(19) United States
(12) Patent Application Publication
(10) Pub. No.: US 2012/0109704 A1
(43) Pub. Date: May 3, 2012

(54) MANAGING UTILIZATION OF BIOGAS IN AN INFRASTRUCTURE

(76) Inventors: Ratnesh Kumar Sharma, Fremont, CA (US); Thomas W. Christian, Fort Collins, CO (US); Martin Arlitt, Calgary (CA); Cullen E. Bash, Los Gatos, CA (US); Chandrakant Patel, Fremont, CA (US)

(21) Appl. No.: 12/913,494

(22) Filed: Oct. 27, 2010

(51) Int. Cl. G06Q 10/00

(52) U.S. Cl. 705/7.22

(57) ABSTRACT

A system for managing utilization of biogas in an infrastructure includes a plurality of biogas implementing apparatuses. The system also includes a biogas source to supply biogas to the plurality of biogas implementing apparatuses and an optimizer to determine a distribution of the biogas to the plurality of biogas implementing apparatuses that substantially optimizes at least one metric associated with operating the infrastructure.

### BACKGROUND

Data centers, which provide controlled environments for Information Technology (IT) equipment, play an increasingly important role in modern society. However, due to the substantial power consumption of data centers and their rapid growth in numbers, the design and operation of data center infrastructures is one of the primary challenges facing IT organizations and economies alike. Unprecedented growth in the demand for IT services has led to development of large, complex, resource-intensive IT infrastructures to support pervasive computing. Emerging high-density computer systems and centralization of disaggregated IT resources are known to increasingly exhaust existing data center capacity.

Beyond the need for additional capacity, data centers also face uncertainty on the supply side. Reduced available capacity margins in the power grid, limited growth in energy transmission and distribution infrastructure, emission control regulations and high cost of reliable energy present significant techno-commercial hurdles to availability of the robust IT infrastructure necessary to sustain economic growth.

### BRIEF DESCRIPTION OF THE DRAWINGS

Features of the present disclosure will become apparent to those skilled in the art from the following description with reference to the figures, in which:

FIG. 1A shows a simplified block diagram of an infrastructure for which utilization of biogas is managed, according to an example of the disclosure;

FIG. 1B shows a simplified block diagram of an infrastructure for which utilization of biogas is managed, according to another example of the disclosure;

FIG. 2 shows a simplified block diagram of an optimizer for managing utilization of biogas in an infrastructure, according to an example of the disclosure;

FIG. 3 illustrates a flow diagram of a method of managing utilization of biogas in an infrastructure, according to an example of the disclosure; and

FIG. 4 illustrates a computer system, which may be employed to perform various functions of the optimizer depicted in FIG. 2 in performing some or all of the processes contained in the diagrams depicted in FIG. 3, according to an example of the disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on.

Disclosed herein are systems and methods for managing utilization of biogas in an infrastructure. As described in greater detail below, the distribution of biogas to a plurality of biogas implementing apparatuses that substantially optimizes at least one metric associated with operating the infrastructure is determined. The biogas implementing apparatuses may comprise various types of apparatuses that implement the biogas. According to an example, the biogas implementing apparatuses include an electrical energy generator and a thermal energy generator. In this example, the energy generated from the electrical energy generator and the thermal energy generator are consumed by a plurality of energy consuming components. The plurality of energy consuming components may include, for instance, at least one computing component and at least one cooling component.

The method and apparatus disclosed herein may be used to design a synergistic system that includes an energy supply source, such as but not limited to biogas implementing apparatuses that receive biogas from a biogas source, and different demand sites, such as but not limited to a computing facility and an organic mass processing facility. Additionally, one or more of the demand sites, for instance the organic mass processing facility, may in turn supply the organic materials used to produce the biogas.

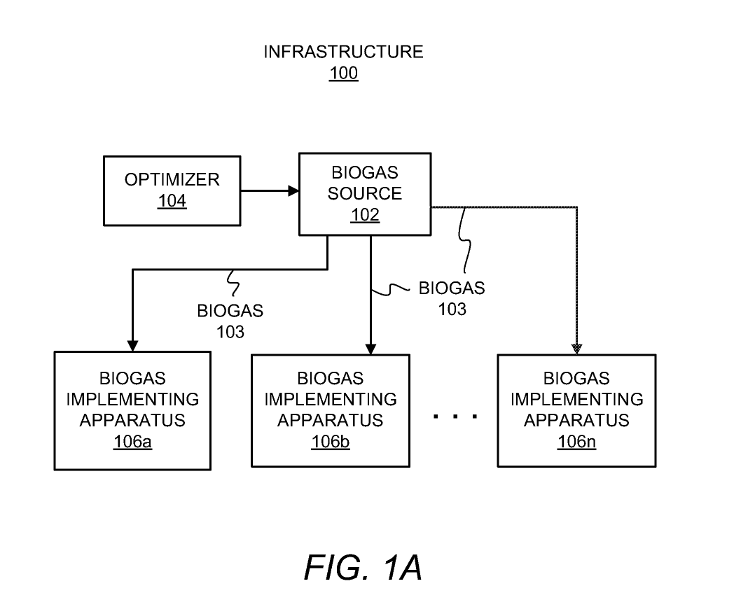

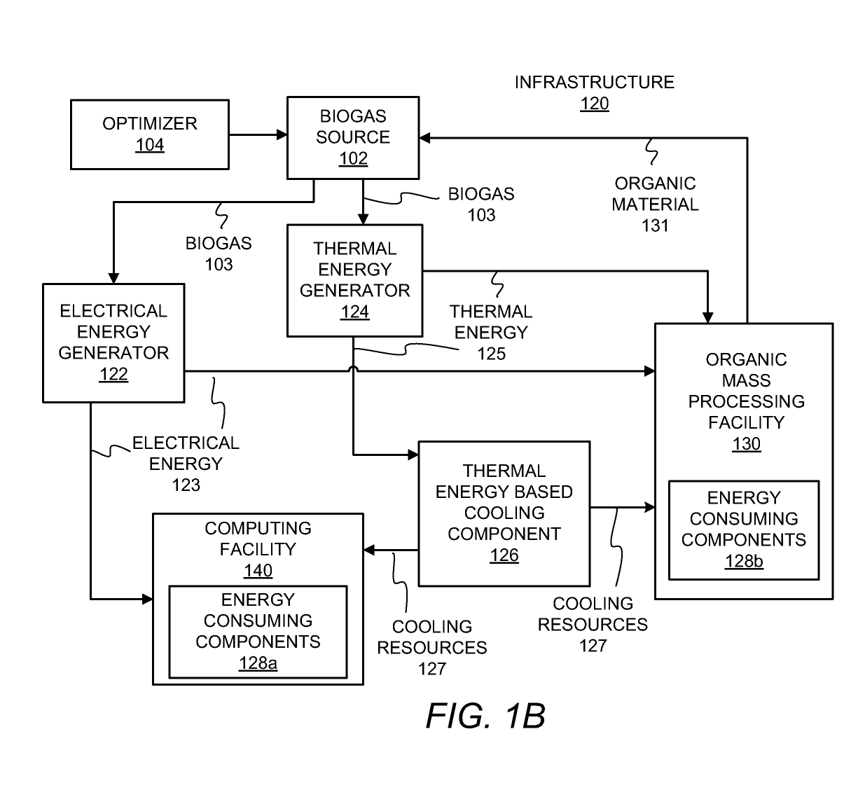

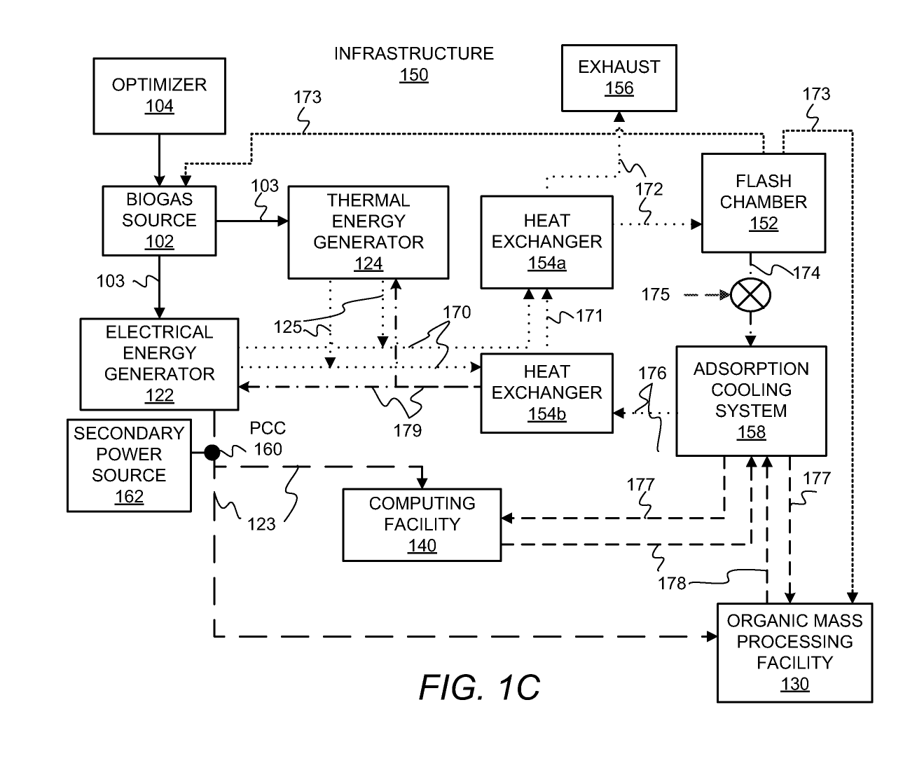

With reference first to FIG. 1A, there is shown a block diagram of an infrastructure 100 for which utilization of biogas is managed, according to an example. It should be understood that the infrastructure 100 may include additional components and that one or more of the components described herein may be removed and/or modified without departing from a scope of the infrastructure 100.

The infrastructure 100 includes a biogas source 102, an optimizer 104, and a plurality of biogas implementing apparatuses 106a-106n. The infrastructure 100 is managed and operated as a composite unit in which biogas generated by the biogas source 102 is implemented by the plurality of biogas implementing apparatuses 106a-106n in a manner that substantially optimizes at least one metric associated with operating the infrastructure 100.

The plurality of biogas implementing apparatuses 106a-106n may implement the biogas for a plurality of uses. For instance, the plurality of biogas implementing apparatuses 106a-106n may implement the biogas 103 for uses such as but not limited to thermal energy generation, electrical energy generation, as biogas injected into a gas distribution system, in the production of fertilizer, in the production of plastics and/or fabrics, as Methanol and/or fuel additives, etc. Accordingly, the plurality of biogas implementing apparatuses 106a-106n may comprise devices such as, but not limited to, an electrical energy generator, a thermal energy generator, a directed biogas consuming apparatus, a fertilizer distribution apparatus, a manufacturing apparatus, a fuel additive distribution apparatus, etc.

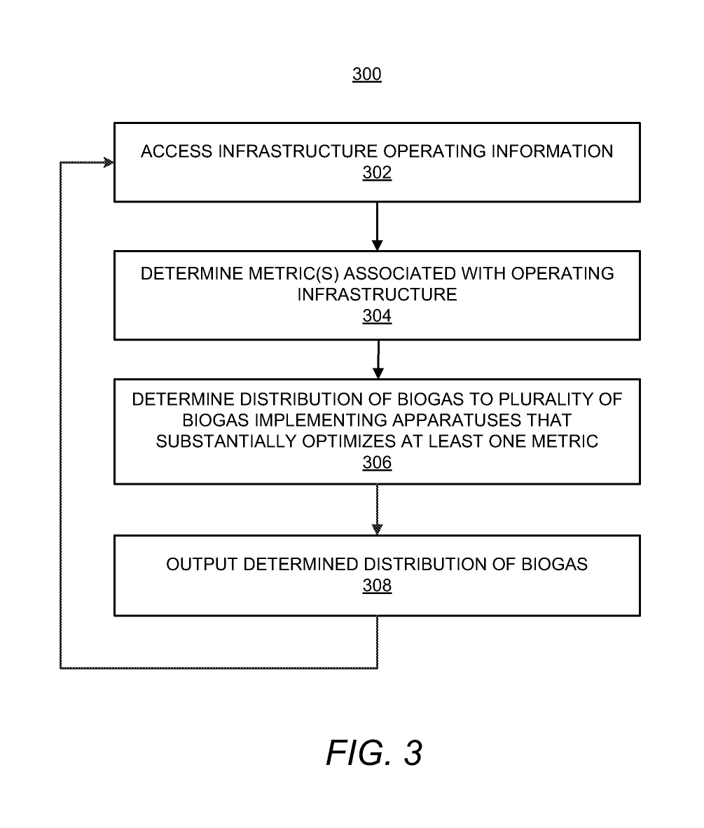

The optimizer 104 directs distribution of the biogas 103 from the biogas source 102 to the plurality of biogas implementing apparatuses 106a-106n in a manner that substantially optimizes at least one metric associated with operating the infrastructure 100. The at least one metric associated with operating the infrastructure 100 may comprise a metric such as, but not limited to a total cost of operation (TCO), loss in available energy carbon emissions, toxicity, etc. The optimizer 104 may substantially optimize the at least one metric associated with operating the infrastructure 100, for instance as described hereinbelow with respect to the method 300 depicted in FIG. 3.

With reference now to FIG. 1B, there is shown a block diagram of an infrastructure 120 for which utilization of biogas is managed, according to an example. It should be understood that the infrastructure 120 may include additional components and that one or more of the components described herein may be removed and/or modified without departing from a scope of the infrastructure 120. The infrastructure 120 is a particular application of the infrastructure 100 disclosed with respect to FIG. 1A hereinabove. As such, the infrastructure 120 includes many of the same elements as those depicted in the infrastructure in FIG. 1A.

The infrastructure 120 includes a biogas source 102, an optimizer 104, an electrical energy generator 122, a thermal energy generator 124, a thermal energy based cooling component 126, an organic mass processing facility 130 and a computing facility 140. The computing facility 140 may comprise, for instance, a data center and the organic mass processing facility 130 may comprise, for instance, a farm facility, an animal waste collection facility, a landfill site, a wastewater treatment facility, a sewage processing facility, a food processing facility, etc., that may produce and process organic material 131 that may be used as a source of fuel by the biogas source 102 to generate biogas, such as but not limited to, methane. Alternatively, however, the organic mass processing facility 130 may supply the organic material 131 to another facility (not shown) for generation of the biogas and the biogas source 102 may comprise a facility or infrastructure configured to distribute the biogas 103. In any regard, the infrastructure 120 is managed and operated as a composite unit for which a substantial amount of the energy consumed is generated from the biogas produced and/or supplied from the biogas source 102.

As shown in FIG. 1B, the biogas source 102 is configured to supply biogas 103 to the electrical energy generator 122 and the thermal energy generator 124. The electrical energy generator 122 and the thermal energy generator 124 are particular examples of the plurality of biogas implementing apparatuses 106a-106n, described hereinabove with respect to FIG. 1A. According to an example, the biogas source 102 is configured to control the amount of biogas 103 supplied to the electrical energy generator 122 and the thermal energy generator 124, for instance, based upon instructions received from the optimizer 104. The electrical energy generator 122 is configured to generate electrical energy from the biogas 103 and the thermal energy generator 124 is configured to generate thermal energy from the biogas, for instance, by burning the biogas 103. As also shown in FIG. 1B, the electrical energy generator 122 supplies the generated electrical energy 123 to the computing facility 140 and the organic mass processing facility 130. The electrical energy 123 is thereafter provided to energy consuming components 128a and 128b of the infrastructure 120, which may comprise parts of the organic mass processing facility 130 and/or the computing facility 140. In addition, the thermal energy generator 124 supplies the generated thermal energy 125 to the thermal energy based cooling component 126 and to the organic mass processing facility 130. Although not shown, the electrical energy generator 122 may also supply the generated electrical energy 123 to the thermal energy based cooling component 126 and the thermal energy generator 124 may also supply the generated thermal energy 125 to the computing facility 140.

As also shown in FIG. 1B, the thermal energy based cooling component 126 provides cooling resources 127 to the organic mass processing facility 130 and the computing facility 140. The cooling resources 127 may include, for instance, cooling airflow, chilled water, chilled refrigerant, etc. In any regard, the thermal energy based cooling component 126 may use the thermal energy 125 in an adsorption cooling process as discussed in greater detail herein below.

The computing facility 140 may comprise a relatively static structure, such as but not limited to, a temporary or a permanent building. Alternatively, the computing facility 140 may comprise a mobile structure, such as but not limited to a mobile data center contained in a trailer. According to one or more examples, the computing facility 140 houses computing and electronic equipment, which have generally been depicted in FIG. 1B as energy consuming components 128a. In addition, the computing facility 140 may include one or more fluid supplying apparatuses (not shown) configured to employ the cooling resources 127 in supplying cooling airflow or other fluid to dissipate heat generated by the energy consuming components 128a. As such, the computing facility 140 may utilize the electrical energy 123 to operate the energy consuming components 128a and/or the fluid supplying apparatuses.

The organic mass processing facility 130 may comprise a facility at which organic mass is collected and/or processed. Examples of suitable organic mass processing facilities 130 include, for instance, a farm facility, an animal waste collection facility, a landfill site, a wastewater treatment facility, a sewage processing facility, a food processing facility, etc. The organic mass processing facility 130 may utilize the thermal energy 125 to, for instance, heat the interior of the facility 130. In addition, the organic mass processing facility 130 may utilize the electrical energy 123 to power the energy consuming components 128b, which may include, for instance, various machinery, lights, etc., contained in the organic mass processing facility 130. The organic mass processing facility 130 may also utilize the cooling resources 127 to cool the interior of the facility 130.

As further shown in FIG. 1B, the optimizer 104 communicates with the biogas source 102 to, for instance, control distribution of the biogas 103 to the electrical energy generator 122 and the thermal energy generator 124. More particularly, the optimizer 104 is to determine a biogas 103 distribution between the electrical energy generator 122 and the thermal energy generator 124 that substantially optimizes at least one metric associated with operation of the infrastructure 120. The at least one metric may comprise, for instance, total cost of operation (TCO), carbon emissions, loss of available energy, toxicity, etc. Thus, for instance, the optimizer 104 may determine a biogas 103 distribution between the electrical energy generator 122 and the thermal energy generator 124 that substantially minimizes the TCO of the infrastructure 120 as a whole or the TCO of one or more of the infrastructure components, such as but not limited to, the computing facility 140.

Turning now to FIG. 1C, there is shown a simplified block diagram of an infrastructure 150 for which utilization of biogas may be managed, according to another example. It should be understood that the infrastructure 150 may include additional components and that one or more of the components described herein may be removed and/or modified without departing from a scope of the infrastructure 150. The infrastructure 150 is a particular application of the infrastructure 100 disclosed with respect to FIG. 1B hereinabove. As such, the infrastructure 150 includes many of the same elements as those depicted in the infrastructure in FIG. 1B.

As depicted in FIG. 1C, in addition to the biogas source 102, optimizer 104, electrical energy generator 122, thermal energy generator 124, organic mass processing facility 130, and computing facility 140, the infrastructure 150 includes a flash chamber 152, a plurality of heat exchangers 154a-154b, an exhaust 156, and an adsorption cooling system 158. In one regard, the thermal energy based cooling component 126 depicted in FIG. 1B has been replaced with various cooling components for enabling adsorption based cooling. FIG. 1C further illustrates the flow of energy in the infrastructure 150, particularly the flow of secondary heat captured from the electrical energy generator 122 and the thermal energy generator 124, which may alternately be referred to as waste heat capture. FIG. 1C also shows various other flows of energy and fluids in the infrastructure 150.

The infrastructure 150 is also depicted as being configured to receive power at a point of common coupling (PCC) 160 from a secondary power source 162, which may be used to supplement electrical energy produced by the electrical energy generator 122. The secondary power source 162 may comprise a utility, or alternately, a secondary power generator. In instances in which the secondary power source 162 is a utility, the infrastructure 150 may be further configured to output excess power generated from the electrical energy generator 122 to the utility company, for instance, under a prior agreement to thereby recoup some of the costs associated with receiving power from the utility company. In other instances, the infrastructure 150 may be coupled to both a utility and a secondary generator. This arrangement provides enhanced stability in the electrical energy supply for critical applications. For example, in instances in which electrical energy from the utility is unavailable and the electrical energy 123 produced by the electrical energy generator 122 is insufficient, the secondary generator may provide electrical energy to ensure continued functioning of the data center.

The electrical energy generator 122 and engine cooling systems (not shown) associated with the electrical energy generator 122 produce either hot water or low pressure steam that may be use in combined heat and power (CHP) applications. As shown, the waste heat 170 from the electrical energy generator 122 is supplied to the heat exchangers 154a and 154b, which may operate at different temperatures with respect to each other. In many instances, CHP system efficiencies (electricity and useful thermal energy) of 70 to 80% may be routinely achieved with natural gas engine systems. Potential distributed generation applications for reciprocating engines include standby, peak shaving, grid support, and CHP applications in which hot water, low-pressure steam or waste heat-fired chillers are required. The economics of natural gas engines in on-site generation applications are enhanced by effective use of the thermal energy contained in the exhaust gas and cooling systems as depicted in FIG. 1C.

The thermal energy generator 124 is configured to provide additional heat or additional hot water as required for the organic mass processing facility 130. According to an example, the thermal energy generator 124 comprises a gas burning furnace having tubes through which water is flowing. The heated water (thermal energy 125) is then supplied to the heat exchangers 154a and 154b, for example, in instances in which the heated water 170 from the electrical energy generator 122 is insufficient. For instance, the waste heat 170 supplied to the heat exchanger 154b may be at around 90° C. and the waste heat 170 supplied to the heat exchanger 154a may be at around 400° C. Heated water or other fluid may also be supplied from the heat exchanger 154b at the lower temperature to the heat exchanger 154a at the higher temperature as indicated by the arrow 171. In addition, the heated water or steam may be either be supplied to the flash chamber 152 or may be exhausted out of the infrastructure 150, as indicated by the arrow 172.

The flash chamber 152 may be divided proportionally based on an amount of heated water and an amount of steam 173 required for components of the infrastructure 150. The flash chamber 152 may be configured to perform in an analogous manner to a control knob. By way of illustration, the flash chamber 152 may contain pressurized heated water. The pressure in the flash chamber 152 may be manipulated in order to proportionally produce required amounts of heated water and steam 173. As shown, the heated water and steam 173 may be supplied to the biogas source 102 and/or the organic mass processing facility 130.

The adsorption cooling system 158 is configured to receive the heated water and steam from the flash chamber 152 as indicated by the arrow 174. The flow of fluid to the adsorption cooling system 158 may include a controlled mixing of make-up water 175, for instance, at around 30° C. The adsorption cooling system 158 includes three fluid circuits (not shown) through which fluid may be circulated in the adsorption process. For instance, heated water received from the flash chamber 152 provides energy required for media in the adsorption cooling system 158 to release refrigerant vapor. Heat from the adsorption cooling system 158 may thereafter be released to the environment using a cooling tower (not shown). In addition, or alternatively, the heat may be supplied to the heat exchanger 154b as depicted by the arrow 176. Moreover, fluid from which heat has been absorbed by the heat exchanger 154b may be returned to the electrical energy generator 122 and the thermal energy generator 124 as indicated by the arrows 179.

The adsorption cooling system 158 may be sized based upon a coefficient of performance of the adsorption cooling system 158. For instance, the intake and output of the adsorption cooling system 158 may be measured for both volume and temperature, and a synergy balance thereafter determined. In addition, the cooling fluid produced by the adsorption cooling system 158 may be provided to the computing facility 140 and to the organic mass processing facility 130 as indicated by the arrows 177. The cooling fluid may also be returned back to the adsorption cooling system 158 from the computing facility 140 and the organic mass processing facility as indicted by the arrows 178.

The adsorption cooling system 158 provides benefits to the infrastructure 150 as compared to an absorption chiller. In contrast to the absorption chiller, the adsorption cooling system 158 does not require substantial infrastructure to heat up a desorber and absorption chiller. Additionally, maintenance costs for the absorption chiller are known to be relatively greater than maintenance costs for the adsorption cooling system 158.

Components of the infrastructure 150 may be further configured to further utilize energy produced as a result of energy consumption by other components of the infrastructure 150. For instance, thermal energy produced as a result of consumption of electrical energy in the computing facility 140 may be used by the adsorption cooling system 158 or by the biogas source 102 in producing the biogas. Additionally, low grade heat produced by computing processes in the computing facility 140 such as but not limited to warm rack exhaust may be directed to the organic mass processing facility 130, for instance, to provide heat in barn associated with the organic mass processing facility 130. Alternately, the heat produced from computing processes may be directed to the biogas source 102, for instance an anaerobic digester.

According to an example, an anaerobic digester may be employed to generate the biogas from the organic material 131 (FIG. 1B). Anaerobic digestion is a process by which organic materials in an enclosed vessel are broken down by microorganisms, in the absence of oxygen. The anaerobic digestion process produces biogas (comprised primarily of methane and carbon dioxide). The ultimate yield of biogas depends on the composition and biodegradability of organic feedstock, but the production rate of the biogas depends on the population of microorganisms, their growth conditions, and fermentation temperature.

The anaerobic digestion process is known to produce substantial amounts of solids that, in particular instances, may be used as a fertilizer, for instance at the organic mass processing facility 130. Alternately, the solid byproducts of the anaerobic digestion process may be stored for later usage or incinerated. The solid byproducts may also be used for landscaping or compacting. In any regard, the biogas produced by the anaerobic digester is thereafter input to the plurality of biogas based energy generators, which may produce and distribute energy under direction from the optimizer 104. In addition, the biogas source 102 may store the bioagas or may obtain the biogas from a separate storage location.

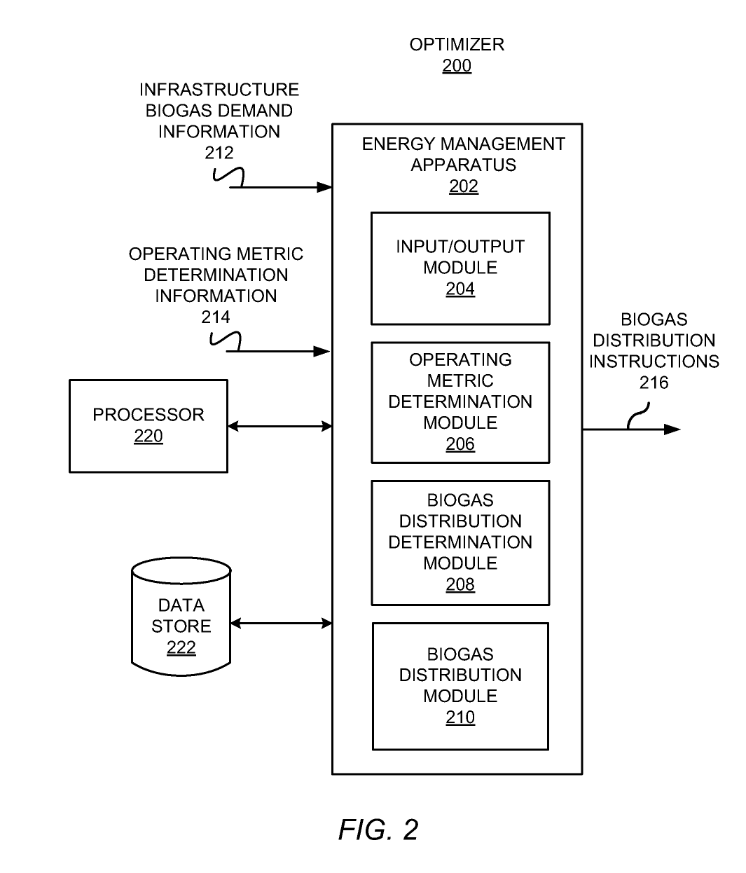

Turning now to FIG. 2, there is shown a block diagram of an optimizer 200 for substantially optimizing at least one metric associated with operating the infrastructure 100, 120, 150 depicted in FIGS. 1A, 1B and 1C, according to an example. It should be understood that the optimizer 200 may include additional components and that one or more of the components described herein may be removed and/or modified without departing from a scope of the optimizer 200.

The optimizer 200, which may comprise the optimizer 104 depicted in FIG. 1A, includes an energy management apparatus 202, a processor 220, and a data store 222. Generally speaking, the energy management apparatus 202 is configured to determine a distribution of the biogas 103 to the plurality of biogas implementing apparatuses 106a-106n that substantially optimizes at least one metric associated with operating the infrastructure 100.

The energy management apparatus 202 is configured to be implemented and/or executed by the processor 220, which may comprise a microprocessor, a micro-controller, an application specific integrated circuit (ASIC), and the like. Thus, for instance, the optimizer 200 may comprise a computing device and the energy management apparatus 202 may comprise an integrated and/or add-on hardware device of the computing device. As another example, the energy management apparatus 202 may comprise a computer readable storage device (not shown) upon which is stored one or more computer programs, which the processor 220 is configured to execute.

The energy management apparatus 202 includes an input/output module 204, an operating metric determination module 206, a biogas distribution determination module 208, and a biogas distribution module 210. The modules 204-210 may comprise modules with machine readable instructions, hardware modules, or a combination of modules with machine readable instructions and hardware modules. Thus, in one example, one or more of the modules 204-210 comprise circuit components. In another example, one or more of the modules 204-210 comprise machine readable instructions stored on a computer readable storage medium, which the processor 220 is configured to execute. As such, in one example, the energy management apparatus 202 comprises a hardware device, such as but not limited to, a computer, a server, a circuit, etc. In another example, the energy management apparatus 202 comprises a computer readable storage medium upon which machine readable instructions for performing the functions of the modules 204-210 are stored. The various functions that the energy management apparatus 202 performs are discussed in greater detail hereinbelow.

The input/output module 204 is configured to access information, for instance, to receive information from infrastructure components (as shown for instance with in FIGS. 1A-1C and discussed hereinabove) of the infrastructure 100, 120, 150 or alternately access information previously received and stored in the data store 222, that may be used to determine a metric associated with operating the infrastructure, hereinafter operating metric determination information 214. The input/output module 204 may also receive information that may be used to determine a metric associated with operating the infrastructure 100 from sources external to the infrastructure, for instance from regulatory agencies, manufacturers/operators of the computing facility 140 and/or the organic mass processing facility 130, etc. The operating metric may comprise, for instance, a sustainability metric, such as but not limited to loss in available energy or carbon emissions, or a total cost of operation (TCO), as described hereinbelow with respect to FIG. 3 and the method 300.

The input/output module 204 is also configured to access and/or receive information that may be used to determine biogas demand from each component of the infrastructure, hereinafter infrastructure biogas demand information 212. The infrastructure biogas demand information 212 may include demand for energy based on the biogas, such as but not limited to thermal energy demand, electrical energy demand, cooling demand, and/or other demand for the components of the infrastructure 100. Additionally, the infrastructure biogas demand information 212 may include demand for biogas for other uses, such as but not limited to biogas to be injected into a gas distribution system, biogas to be used in the production of fertilizer, biogas to be used in the production of plastics and/or fabrics, biogas to be used as methanol and/or fuel additives, etc.

The operating metric determination module 206 is configured to determine the at least one metric associated with operating the infrastructure using the operating metric determination information 214. By way of example in which the metric is the TCO of the infrastructure 100, the operating metric determination module 206 may determine the TCO at various times during the day, under differing loading conditions of the computing facility 140, organic mass processing facility 130, and thermal energy based cooling component 126, under various biogas distribution levels between the electrical energy generator 122 and the thermal energy generator 124, etc. Thus, for instance, the operating metric determination module 206 may track the TCO of the infrastructure 100 under various conditions and may store the tracked information, for instance, in the data store 222.

The biogas distribution determination module 208 is configured to determine a distribution of the biogas 103 to the plurality of biogas implementing apparatuses 106a-106n that substantially optimizes at least one metric associated with operating the infrastructure 100 for a period of time. Thus, as described with respect to FIG. 1B hereinabove for instance, the biogas distribution determination module 208 is configured to determine that a first amount of biogas 103 is to be supplied to the electrical energy generator 122 and that a second amount of biogas 103 is to be supplied to the thermal energy generator 124 at a first period of time. At another time, for instance, as conditions change in the infrastructure 100, the biogas distribution determination module 208 may determine that the amounts of biogas 103 to be distributed to the electrical energy generator 122 and the thermal energy generator 124 is to be varied.

The biogas distribution module 210 is configured to output the determined distribution and/or generate control signals 216 to be outputted to the biogas source 102 to cause the biogas source 102 to supply the biogas 103 into the plurality of biogas implementing apparatuses 106a-106n according to the determined distribution. The input/output module 204 may also output the energy distribution instructions 216 to the biogas source 102. In addition, or alternatively, the energy management apparatus 202 may store the biogas distribution instructions 216 in the data store 222.

According to an example, the data store 222 comprises non-volatile byte-addressable memory, such as but not limited to, battery-backed random access memory (RAM), phase change RAM (PCRAM), Memristor, and the like. In addition, or alternatively, the data store 222 may comprise a device configured to read from and write to external removable media, such as but not limited to, removable PCRAM device. Although the data store 222 has been depicted as being internal to the optimizer 200 and attached to the energy management apparatus 202, it should be understood that the data store 222 may be remotely located from the optimizer 200. In this example, the energy management apparatus 202 may access the data store 222 through a network connection, the Internet, etc.

With reference now to FIG. 3, there is shown a flow diagram of a method 300 of managing utilization of biogas in an infrastructure, according to an example. It is to be understood that the following description of the method 300 is but one manner of a variety of different manners in which an example of the disclosure may be practiced. It should also be readily apparent that the method 300 represents a generalized illustration and that other processes may be added or existing processes may be removed, modified or rearranged without departing from a scope of the method 300.

The description of the method 300 is made with reference to the infrastructure 100, 120, 150 depicted in FIGS. 1A-1C and the optimizer 200 depicted in FIG. 2 and thus makes particular reference to the elements contained therein. It should, however, be understood that the method 300 may be implemented in a facility and using an apparatus that differs from the infrastructure 100, 120, 150 and the optimizer 200 depicted in FIGS. 1A, 1B, 1C and 2 without departing from a scope of the method 300.

With particular reference to FIG. 3, at block 302, information associated with operating an infrastructure 100, 120, 150 having a biogas source 102 and a plurality of biogas implementing apparatuses 106a-106n is accessed. The information may comprise the infrastructure biogas demand information 212 and the operating metric determination information 214 discussed above.

At block 304, at least one metric associated with operating the infrastructure 100, 120, 150 is determined from the information accessed at block 302, for instance, by the operating metric determination module 206. As discussed above, the operating metric determination information 214 may include information pertaining to the at least one metric for the components contained in the infrastructure 100, 120, 150. In one example, the information 214 may include previously calculated values for the at least one metric as determined, for instance, by an administrator, a computer program, a manufacturer or components housed in the computing facility 140 and/or the organic mass processing facility 130, etc. In this example, the operating metric determination module 206 may determine the at least one metric associated with operating the infrastructure 100, 120, 150 by aggregating the values pertaining to the various components of the infrastructure 100, 120, 150.

In another example the information 214 may include various values, such as but not limited to, energy consumption, cost of energy, exergy destruction, carbon emissions, waste water production, etc., associated with the computing facility 140 and/or the organic mass processing facility 130 as a whole or the components contained in the computing facility 140 and/or the organic mass processing facility 130. In this example, the operating metric determination module 206 may determine the at least one metric by computing the at least one metric for the components contained in the infrastructure 100, 120, 150. By way of example, in which the at least one metric is the TCO of the infrastructure 100, 120, 150, the operating metric determination module 206 may determine the TCO of the infrastructure 100, 120, 150 at different times as loading conditions on the infrastructure 100, 120, 150 vary.

At block 306, the distribution of the biogas 103 to the plurality of biogas implementing apparatuses 106a-106n that substantially optimizes the at least one metric determined at block 304 is determined, for instance, by the biogas distribution determination module 208. By way of particular example, the plurality of biogas implementing apparatuses 106a-106n may comprise biogas based energy generators, such as but not limited to an electrical energy generator and a thermal energy generator, and biogas based manufacturing equipment, such as but not limited to a directed biogas consuming apparatus, a fertilizer distribution apparatus, a manufacturing apparatus, and a fuel additive distribution apparatus. The biogas may be distributed in various proportions to the biogas implementing apparatuses 106a-106n to substantially minimize the TCO, or alternately to substantially maximize an operating margin of the infrastructure 100, 120, 150 based upon a sale price for the manufactured goods and the cost of energy supplied to the infrastructure 100, 120, 150.

According to another example, as described with respect to FIG. 1B and the infrastructure 120, the biogas distribution determination module 208 may determine that the at least one metric is substantially optimized when the electrical energy generator 122 receives a first amount of the biogas 103 to generate electrical energy and when the thermal energy generator 124 receives a second amount of the biogas 103 to generate thermal energy. Thus, by way of particular example in which the metric comprises the TCO of the infrastructure 100, 120, 150, the biogas distribution determination module 208 may determine that the TCO of the infrastructure 100, 120, 150 may be minimized when more of the available biogas 103 is employed to generate electrical energy for the computing facility 140 and the organic mass processing facility 130 than in using more of the available biogas 103 to generate thermal energy.

The biogas distribution determined at block 306 may vary over time as conditions in the infrastructure 100, 120, 150, the supply of biogas 103, and the cost of energy from secondary power sources 162, vary over time. As such, the method 300 may be implemented in a substantially continuous manner to continuously determine the substantially optimal distribution of the biogas over time. According to an example, the distribution of the biogas determined at block 306 for various loading and other conditions in the infrastructure 100, 120, 150 may be stored in the in the data store 222 and the biogas distribution determination module 208 may access the data store 222 at block 306 to more quickly determine the distribution of the biogas 103.

According to an example, the biogas distribution determination module 208 may determine the biogas distribution at block 306 by formulating an optimization for a supply-side infrastructure with a number of constraints. In this example, the biogas determination module 208 minimizes a cost function for the infrastructure 100, 120, 150 within the following constraints.

S_{i,min}<Sᵢ<S_{i,max}, Eqn (1)

ΣSᵢ=D, Eqn (2)

In Eqn (1), Sᵢ is an output of the i^{th} source, S_{i,min} and S_{i,max} are minimum and maximum bounds, respectively, on production of the i^{th} source, and D is the total demand of the infrastructure 100. The sources (i) comprise the plurality of biogas implementing apparatuses 106a-106n and/or electrical energy generator 122 and the thermal energy generator 124 depicted in FIGS. 1A, 1B and 1C. The cost function corresponding to the infrastructure 100 is minimized as follows using an objective function for the infrastructure (, Eqn (3) objective function for infrastructure=min(ΣFᵢ(Sᵢ).)

In Eqn (3), Fᵢ. is a cost function corresponding to an i^{th} source. This methodology may be applied for different types of dependent or uncorrelated demand, for instance, hot water, chilled water, steam, and electricity. In particular instances, elasticity of demand and supply may be factored into the determination of Eqn (3). For instance, a constraint related to heat required may be added, in addition to a term indicating impact of heat utilization. Metrics such as, but not limited to, water usage energy metric (WUE) may be included as a constraint to limit embedded energy in direct and indirect water usage.

In any regard, at block 308, the of the determined distribution may be outputted, for instance, by the biogas distribution module 210. According to an example, the biogas distribution module 210 may communicate instructions to the biogas source 102 to supply one or more of the biogas implementing apparatuses 106a-106n with their respectively determined amounts of biogas 103. In addition, or alternatively, the biogas distribution module 210 may communicate the determined distribution to the data store 222 for storage of that information on the data store 222.

Some of the operations set forth in the method 300 may be contained as one or more utilities, programs, or subprograms, in any desired computer accessible or readable medium. In addition, the method 300 may be embodied by a computer program, which may exist in a variety of forms both active and inactive. For example, it can exist as machine readable instructions, including software program(s) comprised of program instructions in source code, object code, executable code or other formats. Any of the above can be embodied on a computer readable medium, which include storage devices and signals, in compressed or uncompressed form.

Example computer readable storage devices include conventional computer system RAM, ROM, EPROM, EEPROM, and magnetic or optical disks or tapes. Example computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

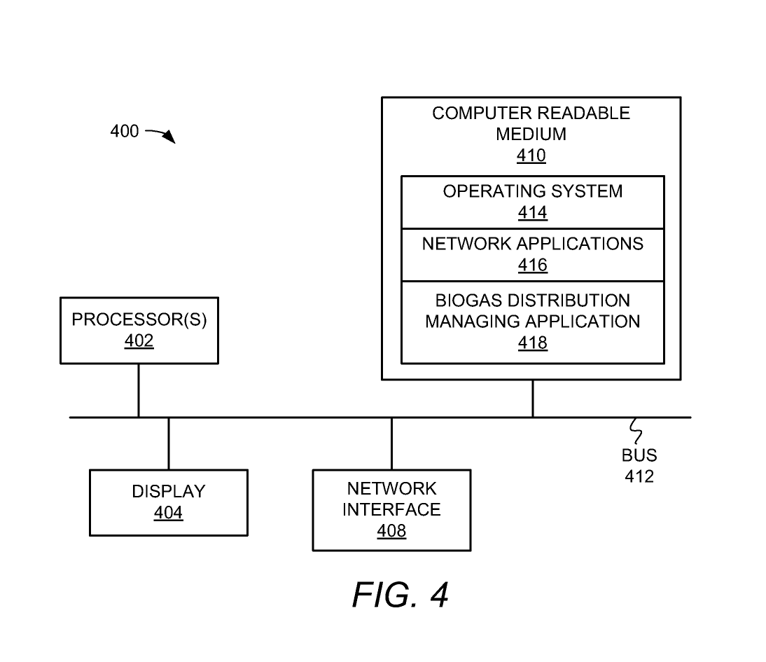

Turning now to FIG. 4, there is shown a schematic representation of a computing device 400 configured in accordance with examples of the present disclosure. The computing device 400 includes one or more processors 402, such as but not limited to a central processing unit; one or more display devices 404, such as but not limited to a monitor; one or more network interfaces 408, such as but not limited to a Local Area Network LAN, a wireless 802.11x LAN, a 3G mobile WAN or a WiMax WAN; and one or more computer-readable mediums 410. Each of these components is operatively coupled to one or more buses 412. For example, the bus 412 may be an EISA, a PCI, a USB, a FireWire, a NuBus, or a PDS.

The computer readable medium 410 may be any suitable medium that participates in providing instructions to the processor 402 for execution. For example, the computer readable medium 410 may be non-volatile media, such as but not limited to an optical or a magnetic disk; volatile media, such as but not limited to memory; and transmission media, such as but not limited to coaxial cables, copper wire, and fiber optics. Transmission media can also take the form of acoustic, light, or radio frequency waves. The computer readable medium 410 may also store other machine readable instructions, including word processors, browsers, email, Instant Messaging, media players, and telephony machine readable instructions.

The computer-readable medium 410 may also store an operating system 414, such as but not limited to Mac OS, MS Windows, Unix, or Linux; network applications 416; and a biogas distribution managing application 418. The operating system 414 may be multi-user, multiprocessing, multitasking, multithreading, real-time and the like. The operating system 414 may also perform basic tasks such as but not limited to recognizing input from input devices, such as but not limited to a keyboard or a keypad; sending output to the display 404; keeping track of files and directories on medium 410; controlling peripheral devices, such as but not limited to disk drives, printers, image capture device; and managing traffic on the one or more buses 412. The network applications 416 include various components for establishing and maintaining network connections, such as but not limited to machine readable instructions for implementing communication protocols including TCP/IP, HTTP, Ethernet, USB, and FireWire.

The biogas distribution managing application 418 provides various components with machine readable instructions for managing biogas utilization in an infrastructure, as discussed above. In certain examples, some or all of the processes performed by the application 418 may be integrated into the operating system 414. In certain examples, the processes can be at least partially implemented in digital electronic circuitry, or in computer hardware, machine readable instructions (including firmware and software), or in any combination thereof, as also discussed above.

What has been described and illustrated herein are example of the disclosure along with some variations. The terms, descriptions and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A system for managing utilization of biogas in an infrastructure, said system comprising:
a plurality of biogas implementing apparatuses;
a biogas source to supply biogas to the plurality of biogas implementing apparatuses; and
an optimizer to determine a distribution of the biogas to the plurality of biogas implementing apparatuses that substantially optimizes at least one metric associated with operating the infrastructure.

2. The system according to claim 1, wherein the at least one metric associated with operating the infrastructure comprises at least one metric selected from the group consisting of a total cost of operation (TCO), loss in available energy carbon emissions, and toxicity.

3. The system according to claim 1, wherein the plurality of biogas implementing apparatuses are selected from a group consisting of an electrical energy generator, a thermal energy generator, a directed biogas consuming apparatus, a fertilizer distribution apparatus, a manufacturing apparatus, and a fuel additive distribution apparatus.

4. The system according to claim 1, wherein the infrastructure comprises a plurality of energy consuming components, and wherein the plurality of biogas implementing apparatuses comprise an electrical energy generator and a thermal energy generator to supply the plurality of energy consuming components with one or both of electrical energy and thermal energy generated by the electrical energy generator and the thermal energy generator.

5. The system according to claim 4, wherein the plurality of energy consuming components comprises a computing facility and an organic mass processing facility, wherein the computing facility houses at least one computing component.

6. The system according to claim 5, wherein the optimizer is to substantially continuously determine the distribution of the biogas based upon varying electrical energy and thermal energy demands of one or both of the computing facility and the organic mass processing facility over time.

7. The system according to claim 5, wherein the organic mass processing facility comprises at least one of a farm facility, an animal waste collection facility, a landfill site, a wastewater treatment facility, a sewage processing facility, and a food processing facility.

8. The system according to claim 5, wherein the infrastructure comprises a cooling system, and wherein the cooling system is to receive thermal energy from at least one of the plurality of biogas implementing apparatuses and to use the thermal energy to cool cooling fluid supplied to one or both of the computing facility and the organic mass processing facility.

9. The system according to claim 8, wherein the cooling system comprises an adsorption cooling system.

10. The system according to claim 1, wherein the optimizer is to substantially continuously determine the distribution of the biogas based upon varying levels of biogas availability over time.

11. The system according to claim 1, wherein the optimizer is further to minimize a cost function for the infrastructure using:
cost function for infrastructure=min (ΣF.ᵢ(Sᵢ)),
wherein Fᵢ. is a cost function corresponding to an i^{th} source, Sᵢ is the output of an i^{th} source, and S_{i,min}<Sᵢ<S_{i,max},
wherein S_{i,min} and S_{i,max} are minimum and maximum bounds, respectively, on production of the i^{th} source,
wherein ΣSᵢ=D,
wherein D is a total demand of the infrastructure.

12. A method of managing utilization of biogas in an infrastructure, said method comprising:
accessing information associated with operating the infrastructure, wherein the infrastructure includes a biogas source and a plurality of biogas implementing apparatuses;
determining at least one metric associated with operating the infrastructure from the accessed information; and
determining a distribution of the biogas to the plurality of biogas implementing apparatuses that substantially optimizes the at least one metric.

13. The method according to claim 12, wherein determining the at least one metric further comprises determining at least one metric selected from the group consisting of a total cost of operation (TCO), loss in available energy carbon emissions, and toxicity.

14. The method according to claim 12, wherein the infrastructure comprises a plurality of energy consuming components, and wherein the plurality of biogas implementing apparatuses comprise an electrical energy generator and a thermal energy generator to supply the plurality of energy consuming components with one or both of electrical energy and thermal energy generated by the electrical energy generator and the thermal energy generator, said method further comprising:
determining the distribution of the biogas based upon varying electrical energy and thermal energy demands of the plurality of energy consuming components over time.

15. The method according to claim 12, further comprising:
determining the distribution of the biogas based upon varying levels of biogas availability over time.

16. The method according to claim 12, wherein determining the distribution of the biogas further comprises determining the distribution of the biogas to minimize a cost function for the infrastructure.

17. The method according to claim 16, wherein minimizing the cost function further comprises minimizing the cost function for the infrastructure using:
cost function for infrastructure=min (ΣF.ᵢ(Sᵢ)),
wherein Fᵢ. is a cost function corresponding to an i^{th} source, Sᵢ is the output of an i^{th} source, and S_{i,min}<Sᵢ<S_{i,max},
wherein S_{i,min} and S_{i,max} are minimum and maximum bounds, respectively, on production of the i^{th} source,
wherein ΣSᵢ=D,
wherein D is a total demand of the system.

18. A computer readable storage medium on which is embedded one or more computer programs, said one or more computer programs implementing a method for managing utilization of biogas in an infrastructure, said one or more computer programs comprising computer readable code to:
access information associated with operating the infrastructure, wherein the infrastructure includes a biogas source and a plurality of biogas implementing apparatuses;
determine at least one metric associated with operating the infrastructure from the accessed information; and
determine a distribution of the biogas to the plurality of biogas implementing apparatuses that substantially optimizes the at least one metric.

19. The computer readable storage medium according to claim 18, wherein the infrastructure comprises a plurality of energy consuming components, and wherein the plurality of biogas implementing apparatuses comprise an electrical energy generator and a thermal energy generator to supply the plurality of energy consuming components with one or both of electrical energy and thermal energy generated by the plurality of biogas generators, said one or more computer programs further comprising computer readable code to:
determine the distribution of the biogas based upon at least one of varying electrical energy and thermal energy demands of the plurality of energy consuming components over time, and varying levels of biogas availability over time.

20. The computer readable storage medium according to claim 18, said one or more computer programs further comprising computer readable code to:
determine the distribution of the biogas to minimize a cost function for the infrastructure.
